(19) United States
(12) Patent Application Publication
(10) Pub. No.: US 2024/0077597 A1
(43) Pub. Date: Mar. 7, 2024

(54) Method and Apparatus for a Multistatic Radar Network to Detect Aerial Objects

(71) Applicant: Mitch Randall, Boulder, CO (US)

(72) Inventor: Mitch Randall, Boulder, CO (US)

(21) Appl. No.: 17/980,403

(22) Filed: Nov. 3, 2022

Related U.S. Application Data
(60) Provisional application No. 63/278,090, filed on Nov. 10, 2021.

(51) Int. Cl. G01S 13/00; G01S 7/00; G01S 13/92

(52) U.S. Cl. CPC G01S 13/003; G01S 7/006; G01S 13/92

(57) ABSTRACT

The present invention relates to a method and apparatus for passive multistatic radar detection of aerial objects using preexisting commercial broadcast transmitters and an internet-connected network of passive receivers inexpensive enough and packaged in such a way as to support deployment to nationwide scale by crowd-sourcing.

### CROSS-REFERENCES TO RELATED APPLICATIONS

The present application is a non-provisional utility patent. This application claims the benefit of U.S. Provisional Application Ser. No. 63/278,090, filed on 10, Nov. 2021 which is incorporated herein by reference.

### BACKGROUND OF THE INVENTION

### Field of the Invention

The present invention relates to a method and apparatus for passive multistatic radar detection of aerial objects using preexisting transmitters and a connected network of passive receivers inexpensive enough and packaged in such a way as to support deployment to nationwide scale through a consumer-based citizen science network.

### Description of the Related Art

Systems exist that employ passive multistatic radar techniques to detect aerial objects. These systems are intended for military use and employ techniques and hardware that is cost-prohibitive for a consumer application. Their engineering design and business model is tailored for sparse deployment with limited coverage. Open source passive radar software has become available for inexpensive software defined radio receivers to be operated independent of other sites.

What is needed is a radar capable of detecting aerial objects with nationwide coverage that can be deployed via crowdsourcing. The system must be productized such that unskilled consumers can deploy the system resulting in scientific grade measurements. What is further needed is a system designed specifically for economy such that it can support the growth of a large network of receiver sites. This can happen only if the cost to the consumer is low enough to be outweighed by their interest in participating in the network. What is further needed is a system that adapts to a wide variety of geographical and radio wave configurations to deliver useable data. What is further needed is a mechanism and infrastructure by which data of multiple receivers is combined so as to triangulate to produce object velocity and position tracks in real time.

A feature of the present invention is the use of GPS positioning to locate and report the receiver node position for network definition and data integrity. A further feature of the invention is a phased array antenna for direct signal suppression. A further feature of the invention is timing signal injection or unique digital character injection synchronized to a timing standard. A further feature of the present invention is resampling to achieve timing and range. A further feature of the present invention is matched filter decimation averaging. A further feature of the present invention is reference data compression. A further feature of the present invention is an internet reference routing server. A further feature of the present invention is dynamic reference selection. A further feature of the present invention is cross correlation to determine range gates. A further feature of the present invention is gate time series processing to determine velocity. A further feature of the present invention is pulse pair autocorrelation processing or FFT processing. A further feature of the present invention is first lag coherence detection. A further feature of the present invention is centralized data hub (geographically pyramidal). A further feature of the present invention is multidimensional correspondence Hungarian algorithm. A further feature of the invention is Multiple Hypothesis tracking. A further feature of the invention is Probability Hypothesis Density tracking. A further feature of the present invention is Kalman filter position and velocity optimal estimation. A further feature of the present invention is real-time graphical object informational display. A further feature of the present invention is real-time object track data stream. A further feature of the present invention is local receiver data archival. A further feature of the present invention is central pre-processed data archival. A further feature of the present invention is end-product data archival. These and other features, aspects and advantages of the present invention will become better understood with reference to the following drawings, description and claims.

### BRIEF DESCRIPTION OF THE DRAWINGS

FIG. 1 is a block diagram showing a network node receiving a transmitter sample, two network nodes receiving two object echoes, and connections to a web-based system that routes and processes information.

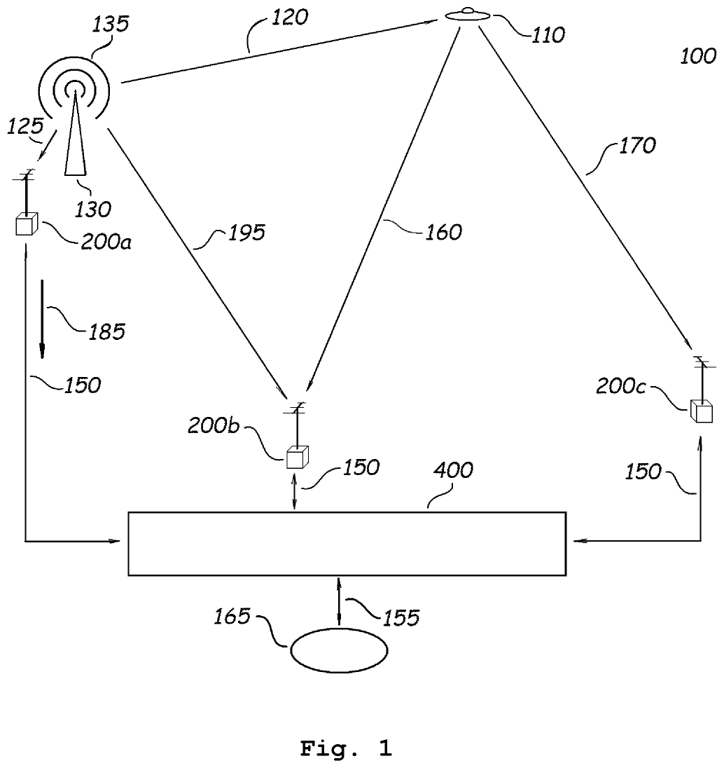

FIG. 2 is a block diagram of a receiver node showing an antenna, receiver, time base, GPS antenna, GPS receiver, host, data archiver, and internet connection.

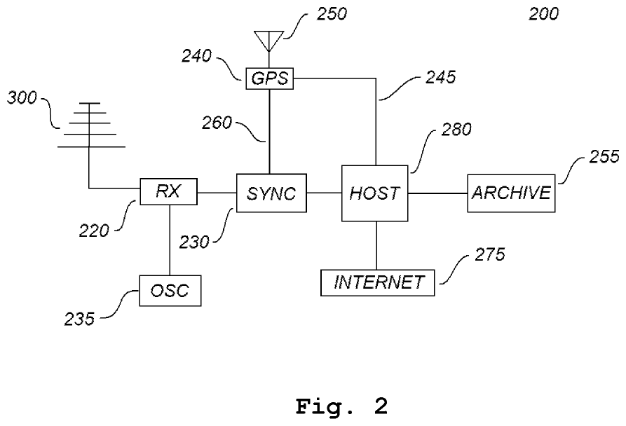

FIG. 3 is a block diagram of a system to inject a timing marker into the analog front end of an RF receiver comprised of a two-sample one-shot, a one-sample one-shot, a pulse generator one-shot, a bandpass filter, an amplifier, and an RF switch.

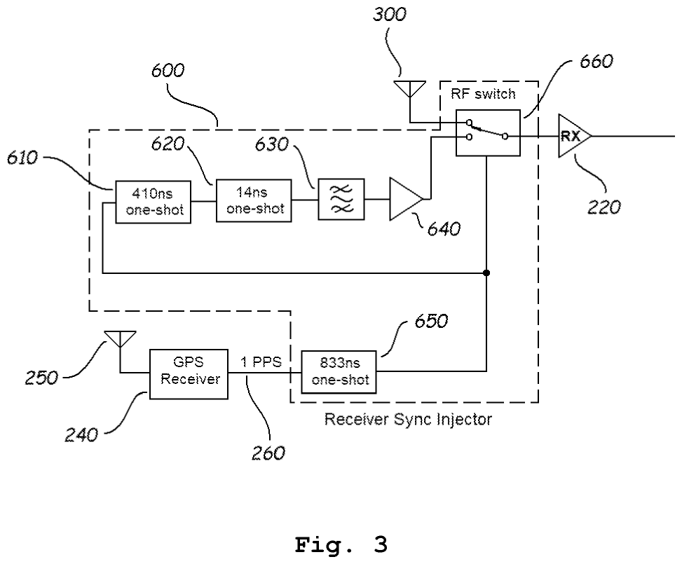

FIG. 4 is a plan view of an antenna array used to form beam patterns that block the direct signal.

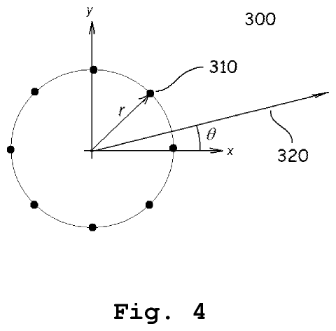

FIG. 5 is an example steerable antenna pattern formed by a phased array antenna showing a sharp null in a direction of about 45 degrees.

FIG. 6 is a block diagram of the data processing path used to detect radar echoes from aerial objects comprising a boxcar decimation filter, a correlator-decimator, a reference signal, and a Doppler radar processor.

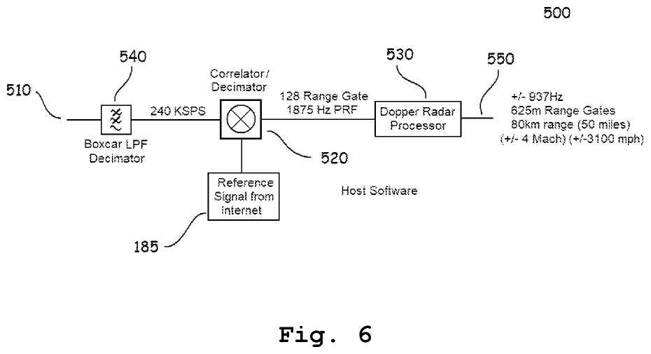

FIG. 7 is a block diagram of the web-based data processor system comprising an object processing and resolving module, a reference server, a central network control host, a civilian radar display server, an object state data streamer, and an archive recorder.

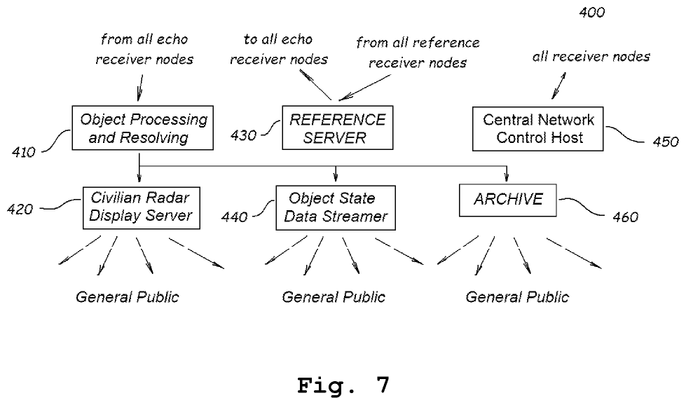

### DETAILED DESCRIPTION OF THE INVENTION

The present invention relates to a configuration 100 generally described as an outdoor arrangement of receiver nodes 200a, 200b, 200c deployed upon the Earth's surface and in proximity to RF transmitter sources 130 separated by as much as several or tens or hundreds of kilometers. Aerial objects 110 are likely in the presence of the substantially omnidirectional radio transmissions 135 of existing RF transmitter sources 130. Such RF transmitter sources 130 include but are not limited to commercial AM, FM, TV, Digital TV, Cellular, and satellite broadcast stations, some of which transmit on average many thousands of Watts of RF power. In some cases, these radio transmissions 135 are transmitted continuously or nearly so. In some cases, these radio transmissions 135 are transmitted in a substantially isotropic fashion in azimuth so as to irradiate aerial objects 110 within a wide azimuthal area. Further, some such radio transmissions 135 are modulated in such a way as to behave as band-limited pink noise with respect to pre-detection autocorrelation.

In the preferred embodiment, receiver node 200a, 200b, 200c connect via internet connection 150 to data processor 400. Data processor 400 transmits and receives data over internet connection 150 and processes intermediate results so as to allow the estimation of the position and velocity of aerial object 110. Additional receiver nodes 200 may be present and contribute to said estimates. However, for clarity, these additional receiver nodes 200 are not shown. The details of the data paths and the processing algorithms are discussed elsewhere in this specification.

An object-directed portion 120 of radio transmission 135 is intercepted and scattered by aerial object 110. A first scattered signal 160 is received by receiver node 200b. A second scattered signal 170 is received by receiver node 200c. Further scattered signals from aerial object 110 may further be incident on one or more additional receiver nodes 200 (not shown). For the purposes of this specification, the operation of only two receiver nodes 200b, 200c are described, because additional receiver nodes 200 operate similarly to those described. It should be noted that additional receiver nodes 200 in diverse locations and in communication with data processor 400 via internet connection 150 serve to improve the overall position and velocity estimates in a least-squares sense. Alternative embodiments of the present invention may rely on recorded data, or alternative means of communication with data processor 400 known to those skilled in the art within the spirit and intention of the present invention.

A nearby portion 125 of radio transmission 135 is intercepted by proximal receiver node 200a. Proximal receiver node 200a digitizes nearby portion 125 as a reference signal 185 representing radio transmissions 135. Reference signal 185 is sent via internet to data processor 400 and redistributed to receiver node 200b, 200c. (Redistributed reference signal 185 is not shown).

The present invention anticipates that receiver nodes 200a, 200b, 200c can operate in various modes, all of which their configurations are not indicated in the figures in order to avoid confusion. For example, other receiver nodes 200b, 200c, may perform the reference capture functionality of proximal receiver node 200a to generate reference signals analogous to reference signal 185. As well, proximal receiver node 200a may process echoes from aerial object 110 as described below. In the preferred embodiment, these various modes are selected by data processor 400 depending on many factors including but not limited to the geographic configuration, the presence of interfering signals, functioning status of a receiver node, etc.

In Remote Reference Mode, Receiver nodes 200c (for example) locally cross correlates reference signal 185 with scattered signal 170 to compute range gates—each range gate representing a specific delay t. Said cross correlations are computed at regular time intervals T, thus each range gate gives rise to time series of period T of other cross correlations at that delay t. The time series are processed by Fourier Transform or other technique to determine Doppler frequency at each delay t.

In Direct Reference Mode, receiver node 200b (for example) receives both a direct signal 195 and a scattered signal 160. Direct signal 195 is used with digital echo cancellation techniques known to those skilled in the art to remove direct signal 195 from scattered signal 160 to create cancelled signal 162. Receiver node 200b locally cross correlates direct signal 195 with cancelled signal 162 to compute range gates—each range gate representing a specific delay t. Said cross correlations are computed at regular time intervals T, thus each range gate gives rise to time series of period T of other cross correlations at that delay t. The time series are processed by Fourier Transform or other technique to determine Doppler frequency at each delay t.

Whether by Remote Reference Mode or Direct Reference Mode, processing local to receiver node 200b, 200c results in an Amplitude, Range, Doppler (ARD) array. In the preferred embodiment, further parameters are computed and associated with locations on the ARD array. These include, but are not limited to, radar cross section estimate, angle of arrival estimate, etc.

The processed data 550 results ARD array of the processing of the range gate time series are sent via internet connection 150 to the data processor 400 where they are used to detect and estimate the position and velocity of aerial object 110. Upon detecting and estimating aerial object(s) 110, the data are formatted and sent via a general internet connection 155 to world-wide users 165 via a web browser or specialized app. (not shown).

In receiver node 200, RF signals received through antenna 300 are converted to baseband by RF receiver 220. In the preferred embodiment, RF receiver 220 is a software defined radio 220. The frequency accuracy of RF receiver 220 relies on free-running time base 235 with good absolute accuracy such as a MEMS-based TCXO or GPS disciplined oscillator. A GPS receiver 240 using GPS antenna 250 computes the location of receiver node 200 and reports it to host 280 via GPS data stream 245. As well, GPS receiver 240 generates a 1 pps signal 260 used for timing synchronization. In the preferred embodiment 1 pps signal 260 is applied to synchronization generator 230, which inserts a known character 290 into the output stream of RF receiver 220 with sub-sample accuracy developed by a counter. In an alternative embodiment, accuracy is limited to one sample interval.

In the preferred embodiment, receiver node 200 is used as both an echo receiver (as in 200b and 200c of the earlier description) or as a reverence receiver (as in 200a of the earlier description), or both. In each of the three cases slightly different processing is executed on host 280. These operational modes are described separately below.

When receiver node 200 is used as a reference receiver, host 280 takes as input the output data stream from synchronization generator 230 and GPS data stream 245. An algorithm in host 280 finds known character 290 in the output of RF receiver 220 in order to count the number of samples between 1 pp signal 260 epochs. Said algorithm finds any occurrence of known character 290 and then looks for a subsequent occurrence of known character 290 within +/−m counts of the expected subsequent location. For example, if the sample rate is 1 MHz, the next known character 290 should occur one million +/−m samples after the first character was detected. Thus, each detection of known character 290 defines a small range 2 m of samples to search over to find the subsequent known character 290. If known character 290 is not found, the algorithm resets and searches for any occurrence of known character 290.

In another embodiment synchronization generator 230 does not respond, and instead receiver sync injector 600 is used between antenna 300 and RF receiver 220. In this embodiment, 1 pps signal 260 triggers one-shot 650 which sets RF switch 660 away from antenna 300 and to amplifier 640 for a duration of two sample periods. One-shot 650 also triggers one-shot 610 to which is timed to create a trigger 7 ns short of one sample period later. The output of one-shot 610 then triggers one-shot 620 whose digital output is filtered by bandpass filter 630 and amplified by amplifier 640 to create a detectable signal in RF receiver 220.

In this alternative embodiment of receiver sync injector 600, the algorithm in host 280 follows the same scheme as in the known character 290 injection scheme of the preferred embodiment. The host algorithm searches for the detectable sync signal as injected into RF receiver 220. Upon finding the signal, the host algorithm searches for the subsequent sync signal within a small range. After detection is complete, the samples affected by the receiver sync injector 600 are interpolated to remove the sync signal so that subsequent radar processing is not affected.

In the preferred embodiment, host 280 uses a Kalman filter to estimate the fractional number of samples found between known character 290 detections. The samples are then resampled to generate resampled data 510 with the desired number of samples. For example, if the sample rate is 1 MHz, and 1,000,023.2843 samples were estimated by the Kalman filter to be arriving between known character 290 epochs, then the data are resampled to create resampled data stream 510 with 1,000,000 samples in that interval. Resampled data stream 510 is passed through a decimation filter, compressed, tagged with known GPS time to create reference signal 185. Reference signal 185 is sent via internet interface 275 to data processor 400.

In an alternative embodiment, sample timing is derived from a GPS disciplined oscillator so that sample timing remains synchronous without a resampling procedure.

In the preferred embodiment, when FM radio stations are used as the RF transmitter source 130, data compression is performed by quantizing the in-phase and quadrature signals to 1 bit each and building a single byte out of four consecutive samples. Thus, the data rate is cut down by a factor of eight.

In an alternative embodiment, other compression methods known to those skilled in the art are used, including no compression.

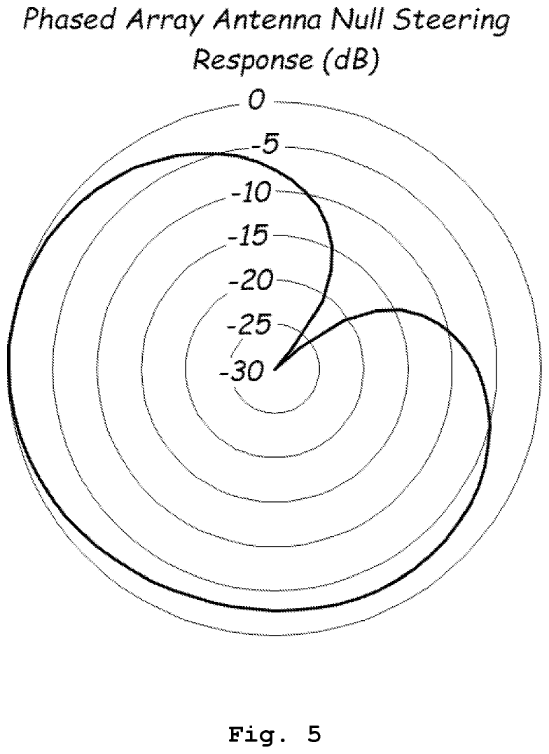

When used as an echo receiver, receiver node 200 operates differently. In the preferred embodiment antenna 300 is an array of a plurality N of vertically polarized antennas 310 equally spaced on the perimeter of an imaginary circle of radius r when viewed from above. Such an arrangement can be on a mast serving as the center of the circle. Each antenna is connected individually to an N-channel RF receiver 220. Beam forming and null steering techniques known by those skilled in the art are used to form a pattern that maximally attenuates direct signal 195. Beam forming is computed in host 280 in the preferred embodiment. This approach results in patterns similar to that of FIG. 5.

To process the received echoes 170 in Remote Reference Mode, host 280 takes as input the output data stream from synchronization generator 230, GPS data stream 245, and reference data 185 from data processor 400 and performs signal processing scheme 500 upon them. To process the received echoes 160 in Direct Reference Mode, host 280 takes as input the output data stream from synchronization generator 230, performs echo cancellation to obtain cancelled signal 162, uses GPS data stream 245, and reference data 195 from data processor 400 and performs signal processing scheme 500 upon them. Received data are tagged with known character 290 and resampled as per described in this specification to generate resampled data stream 510 (not shown). In the preferred embodiment, resampled data stream 510 is decimated in a box-car filter and applied to correlator-decimator 520. As well, reference signal 185 (or direct signal 195) is also input to correlator-decimator 520. The output is an array of time series that are processed on a per-gate basis by Doppler radar processor 530. Doppler radar processor 530 further decimates the data by an integration count W generate output 550. These data are thresholded based on signal to noise ratio and/or signal strength and packaged with GPS time tag as processed data packets 590 (not shown) and sent via internet to data processor 400.

In the preferred embodiment, gate time series are processed using the fast Fourier transform (FFT) in the Doppler radar processor 530 to determine Doppler velocity and signal amplitude. Further, A spatial filter can be employed to determine a Constant False Alarm Rate (CFAR) output that may be compared to a threshold to provide detection of scatter signatures.

In an alternate embodiment, a technique known as pulse pair processing can be employed in the Doppler radar processor 530 to determine Doppler velocity and signal to noise ratio. Further, the first lag autocorrelation amplitude can serve as the detected amplitude because it does not suffer from correlated noise. This improves sensitivity considerably. In addition, a clutter filter can be employed to further remove the direct signal 195 from the result, as well as multipath reflections from ground clutter.

Data processor 400 is comprised of a geographically pyramidal network of host servers configured so as to localize internet traffic between receiver nodes 200. In the preferred embodiment, central network control host 450 communicates with all reference receivers. Central network control host 450 controls operational modalities including but not limited to the definition of which receiver node 200 shall be tasked as a reference receiver or echo receiver, and which receiver nodes 200 are paired with which transmitter reference signals 185. Central network control host can set the receive frequency and radar sampling parameters as well. Central network control host 450 further updates a network connectivity database that is shared among the other functions of the data processor 400.

Central network control host 450 monitors reference signals 185 and processed data packets 590 as well as diagnostic information from receiver nodes 200 relating to the signal noise floor and the amplitude of the direct signal 195. Through a process of trial and error it is determined the best configuration for the best signal. This best configuration may depend on the geographical location of a particular target of interest, and in some cases the configuration, that is the frequency and reference, may be changed in real-time to best track the object. In the preferred embodiment this algorithm is performed by machine learning using a reinforcement learning method.

Reference server 430 receives reference signals 185 from receiver nodes 200 configured as reference receivers and routes them to the appropriate receiver nodes 200 configured as echo receivers.

Object processing and resolving module 410 receives processed data packets 590 from receiver nodes 200 configured as echo receivers and uses the Hungarian correspondence algorithm, and/or Multiple Hypothesis Tracking, and/or Probability Hypothesis Density techniques along with a plurality of geographically diverse Kalman filters to estimate aerial object 110 instances and their 3D position and velocity. In the preferred embodiment, a modified Hungarian algorithm is employed using a multi-dimensional metric including estimates of radar cross section and angle of arrival to help isolate object instances.

In the preferred embodiment, aerial object 110 instances are input to civilian radar display server 420 where they are distinguished from known aircraft tracks and formatted to a plan-view radar display complete with annotated altitude and velocity. The civilian radar display server 420 is connected to user internet space such that the general public can view the radar display on a standard internet browser.

Aerial object 110 instances are packaged into geographically fenced streams by object state data streamer 440 and sent to users and 3 rd party apps for real-time tracking. As an example, a user may have a steerable camera or telescope that could take as input aerial object 110 position and velocity data and effect gimbal steering so as to track and record aerial object 110.

Aerial object 110 instances are archived by archive recorder 460 for later retrieval. Archive recorder 460 may also record processed data packets 590 data so as to be able to recreate aerial object 110 instances as determined in real time by object processing and resolving module 410.

Delays and Doppler shifts measured by receiver nodes 200 are combined with their physical location to determine the one-dimensional, two-dimensional, or three-dimensional position and velocity of aerial objects 110. By the nature of the Kalman filter used to estimate the position and velocity of aerial objects 110, the more receivers located in diverse locations that simultaneously receive RF echoes from a given aerial object 110, the more accurate the position and velocity of aerial object 110 can be estimated in a least-squares sense. Further, the more receivers deployed, the greater the expanse of the detection volume. For example, thousands of receivers nodes 200 deployed across a country could allow three-dimensional position and velocity estimation of aerial objects 110 over the entire airspace of the country.

Thus, a further feature of the present invention through the combination of the many features and overall architecture of the present invention, is that a low-cost receiver node 200 is made possible. Said low-cost receiver node 200 is so economical that civilian hobbyists, enthusiasts, citizen scientists, and interested parties can justify the expense for their interest in participating as one node of a nation-wide aerial object 110 detection network. Thus, low-cost receiver nodes 200 incentivizes the deployment of the densest possible network of receivers nodes 200. This modality of network growth and deployment, herein referred to as crowd-sourcing, is a direct result of the features of the present invention and a key factor driving the present innovation.

Note that although the present invention supports a crowd-sourced radar receiver node 200 network, alternate embodiments and many possible modifications of the present invention are within the spirit of the present invention and are not limited to crowd-sourced networks.

The embodiments of the invention described herein are exemplary and numerous modifications, variations and rearrangements can be readily envisioned to achieve substantially equivalent results, all of which are intended to be embraced within the spirit and scope of the invention as defined in the claims of the present invention.

1. Passive multistatic radar apparatus comprising a plurality of receivers and preexisting radio frequency transmitters in communication with a data processor to determine the position and velocity of aerial objects.

2. The invention of 1 wherein a GPS 1 pps epoch signal is used to inject a marker into the RF receiver sample data stream.

3. The invention of 2 wherein an estimation of the number of samples between said GPS 1 pps epoch markers is used to resample the sampled data to obtain synchronization in time and frequency.

4. The invention of 3 wherein said GPS 1 pps epoch marker is a digital symbol inserted into the digital data stream.

5. The invention of 3 wherein said GPS 1 pps epoch marker is an RF impulse inserted into the analog RF input of the RF receiver.

6. The invention of 3 wherein the RF transmission sources are commercial FM radio stations.

7. The invention of 3 wherein a phased array antenna is used to suppress the direct signal from the transmitter.

8. The invention of 3 wherein a processing system in communication with said plurality of receivers dynamically determines the optimal transmitter-receiver pairing for a given situation.

9. The invention of 6 wherein a geographically pyramidal network of servers minimizes the inter-system data traffic by geographical location.

10. The invention of 8 wherein real-time graphical radar display shows detected aerial objects and associated aerial object information accessible to the public via a web browser.

11. The invention of 9 wherein a real-time aerial object state data stream is transmitted via internet and is accessible by dedicated web client applications.

12. The invention of 9 wherein preprocessed data and fully processed data sent to said geographically pyramidal network of servers is archived to local mass storage.
